(19) United States
(12) Patent Application Publication
(10) Pub. No.: US 2008/0123556 A1
(43) Pub. Date: May 29, 2008

(54) Method And Circuit Arrangement For Carrying Out Initialization And/Or Registration Steps For A Device, In Particular A Household Applicance

(75) Inventors: Peter Bosen, Sinzing (DE); Peter Engl, Laaber (DE); Bernhard Kobl, Sandersdorf (DE); Peter Schweier, Forheim (DE)

Correspondence Address: LERNER GREENBERG STEMER LLP, P O BOX 2480, HOLLYWOOD, FL, 33022-2480, US

(73) Assignee: BSH Bosch und Siemens Hausgerate GmbH

(21) Appl. No.: 11/793,733

(22) PCT Filed: Oct. 27, 2005
(86) PCT No.: PCT/EP05/55596

§ 371 Date: Jul. 12, 2007

(30) Foreign Application Priority Data
Dec. 22, 2004 (DE) 10 2004 061 891.7

(51) Int. Cl. H04L 12/28

(52) U.S. Cl. 370/254

(57) ABSTRACT

A method and a circuit carry out initialization/registration steps for a device, in particular a household appliance, which can be connected to a network. The first initialization/registration of the device is controlled by adding an initialization signal on the actuation of a mechanical circuit device and wherein an address clearly identifying the device in the network is allocated to the device for initialization/registration. In order to carry out the initialization/registration, a control state signal which corresponds to circuit state of circuit device is stored in a flag memory which is associated with the device after the first initialization/registration of the device; after stopping and then restarting the device in the network, the adjusting state of the circuit device is compared to the memory state of the flag memory which corresponds to a determined combination function. A novel initialization/registration of the device in the network takes place only in the presence of a determined, fixed combination relation between the adjusting state of the circuit device of the device and the memory state of the separate flag memory.

The invention relates to a method and a circuit arrangement for carrying out initialisation and/or registration steps for a device, in particular a household appliance which can be connected to a network in which a first initialisation and/or registration of the relevant device is controlled by means of a control device by delivering an initialisation signal from said device in response to an actuation of a mechanical switching device and in which in the course of the relevant initialisation and/or registration, an address clearly identifying this device in said network is allocated to said device.

Initialisation and/or registration step is understood here as a process whereby a device, in particular a household appliance, after this has been physically connected to a network, at least then instigates that a unique address is allocated to said device by which the relevant device can then be reached in the relevant network.

A method and a circuit arrangement for registration of household appliances on a communication network formed by a power supply network are already known (DE 691 05 375 T2). In the relevant known method and the circuit arrangement provided for its implementation, a bistable switching element is provided in each of the household appliances connected to the power supply network which, in its ON position instigates an address allocation by a control device also provided in the network and which in its OFF position, switches off this address request function. Such an address allocation is made for the respective household appliance after its installation. However, this means that when an appliance is re-installed after being previously disconnected from the network, for example in the course of relocating the relevant household appliance in a house or an apartment, the relevant address allocation procedure is carried out anew for this household appliance. Such a renewed or repeated address allocation procedure is dispensable per se since the relevant household appliance has already been allocated an address in the network. As each new address allocation procedure takes place, this is also associated with an undesirable per se additional loading of said network. In this connection, however, no further details are known about any checking of an initialisation and/or registration status of an appliance which has optionally been repeatedly connected or switched to the network.

A procedure corresponding to the known procedure just considered is also known in a network formed by current distributor lines to which various household appliances are connected (EP 0 320 390 B1). In this known system, a re-initialisation of the system is carried out in the event of brief power failures or functional disturbances. In this connection, however, no further details are known about any checking of an initialisation and/or registration status of an appliance which has optionally been repeatedly connected or switched to the network.

Furthermore, a method for registration of an appliance and in particular, a household appliance in a network (DE 689 07 885 T2) is also known in which a monitoring device allows each appliance to be allocated its own identity in the form of a corresponding address. In this case, the procedure is that during the installation of an appliance an identity or address allocation procedure is automatically triggered when the relevant appliance is automatically connected to the power network. However, this means that every time the respective appliance is re-connected or re-switched to the power network, said identity or address allocation procedure takes place for this appliance. Thus, a new address is thereby allocated to the respective appliance in the network to which the relevant appliance is connected although this has already been allocated an address in this network. Furthermore, here also, no further details are known about any checking of an initialisation and/or registration status of an appliance which has optionally been repeatedly connected or switched to the network.

In addition, a tool for the commissioning and for configuration of components of a bus system such as sensors and actuators which can be connected to the respective bus system is also known (DE 101 50 499 A1). In this known tool which is configured as a hardware controller, a detection device is provided for the automatic detection of non-configured components in configuration mode on the bus system. This detects whether components are already configured, i.e. have an address by which they can be reached via the bus system. Non-configured components are understood in this connection as components which have just been connected to the bus system or have been connected again, i.e. components which differ from components which are already connected or still connected to the bus system. Here also however, after every separation of a component from the bus system and after its re-connection to the bus system, the relevant component is thus re-addressed and parametrised. Such re-addressing and parametrisation can also be carried out by components themselves already present on the bus system, by actuating a learning key already provided in each case. The execution of such measures is dispensable per se if the addressing and parametrisation of the respective component after its separation from the bus system and re-connection to the relevant bus system has not changed. However, no further details are known about any checking of an initialisation and/or registration status of an appliance which has optionally been repeatedly connected or switched to the network, which takes this circumstance into account.

Finally a method and a device for controlling a household appliance are already known (WO 02/41569 A2); in this case, a household appliance is connected to a distributed network and receives control information about the network from a service provider. This control information is evaluated and/or implemented at the location of the household appliance. In this context, an individual appliance number of the respective household appliance is used as the address within the network. This appliance number or address of the respective household appliance is filed internally as a unique characteristic in the respective household appliance, for example, in a non-volatile memory module. In this connection, however, nothing is known about measures for undertaking an initialisation and/or registration of an appliance connected to the network or for checking this initialisation and/or registration.

It is thus the object of the invention to provide a way whereby repeated initialisation and/or registration of an appliance, in particular a household appliance in a network containing at least this appliance can be avoided relatively simply in cases where said appliance is removed from the network or switched off after initialisation and/or registration has been carried out and is then connected or switched to the network again.

The object indicated hereinbefore is achieved in a method of the type specified initially according to the invention whereby after the first initialisation and/or registration of the relevant household appliance, an adjusting state signal corresponding to the switching state of said mechanical switching device is stored in a flag memory associated with said device, after the relevant device has been put out of operation and then started up again in said network, the adjusting state of said mechanical switching device is compared with the memory state of the separate flag memory in accordance with a determined combination function and a renewed initialisation and/or registration of the relevant device in said network only takes place when the presence of a determined fixed combination relationship between the adjusting state of the mechanical switching device of said appliance and the memory state of the separate flag memory is established.

By checking the initialisation and/or registration state of an appliance which can be connected to a network containing at least this appliance according to the present invention, the advantage is obtained that a renewed or repeated initialisation and therefore registration of the relevant appliance in said network does not need to be carried out and is not carried out if, after this appliance has first been initialised and registered and then this appliance is put out of operation and possibly removed from the network, the relevant appliance is then re-commissioned again in said network. The relevant appliance has already been allocated a unique address in this network which this appliance can still retain and can still be reached under this address in the network. The address allocation procedure otherwise associated with the re-commissioning of an appliance in the relevant network need not be carried out again in this case which at least means reduced loading of the relevant network and the control device associated therewith which controls said address allocation and identifies the address allocated to the relevant appliance.

It is preferable if the respective adjusting state of the mechanical switching device of said appliance is compared with the memory state of the separate flag memory in accordance with an EXCLUSIVE OR function (non-equivalence) or in accordance with an equivalence function. This has the advantage of a particularly low expenditure on comparison.

Appropriately, the initialisation signal delivered in each case by the mechanical switching device of said appliance is stored in a non-volatile flag memory independent of the power supply of the relevant appliance. This has the advantage of particularly secure storage of the respective initialisation and/or registration of an appliance, in particular a household appliance.

A memory supplied by a dedicated power source, in particular a semiconductor memory is advantageously used as the flag memory of the type just mentioned. This involves a particularly low expenditure on circuitry and control for the flag memory.

Alternatively, a non-electric storage memory, such as in particular a magnetic, optical, magneto-optic or holographic storage memory can be used as the flag memory. Such memories are advantageously completely independent of any power supplies to retain information once this has been stored therein.

A circuit arrangement of the type specified initially is appropriately used for carrying out the method according to the invention, this circuit arrangement being characterised in that a mechanical switching device adjustable between at least two different switching positions is provided in said appliance, which in its different switching positions can deliver initialisation signals which are different from one another (e.g. “0” or “1”), that a flag memory is provided for said appliance (HG1) for storing the initialisation signal delivered in each case by actuation of said mechanical switching device, that a comparison device is provided which can compare the respective adjusting state of the mechanical switching device with the memory state of the separate flag memory before carrying out an initialisation and/or registration of the relevant household appliance, in accordance with a determined combination function for a commissioning and a re-installation of the relevant household appliance following a respective operating interruption and that an evaluation device is provided which only triggers a renewed initialisation and/or registration of the relevant device in said network when the presence of a determined fixed combination relationship between the respective adjusting state of the mechanical switching device and the memory state of the separate flag memory is established.

This yields the advantage of a particularly low expenditure on circuitry to be able to check the initialisation and/or registration of an appliance, in particular a household appliance, in a network containing at least this appliance to which the relevant appliance is connected or switched for the first time or repeatedly. When the relevant appliance is first connected or switched to said network, a unique address is allocated to this appliance in this network. After an operating interruption and the removal of the relevant appliance from the network optionally associated therewith and the subsequent re-connection or switching of this appliance to the network, the relevant appliance does not need to be allocated a new address in this network; rather, this appliance can continue to operate and be reached at the address which had been allocated to it during an earlier, in particular, the first connection or switching to the network. The aforementioned address allocation procedure and the associated loading of the network can thus be omitted.

The comparison device in the circuit arrangement according to the invention is preferably a comparison device which executes an EXCLUSIVE OR function (non-equivalence) or an equivalence function. This results in the advantage of a particularly low expenditure on circuitry for implementing the comparison device.

Appropriately, said flag memory is a non-volatile flag memory independent of the power supply of the relevant appliance which stores the respective initialisation signal. The respective initialisation signal can thus advantageously be retained particularly securely.

It is advantageous if the relevant flag memory is formed by a memory supplied by a dedicated power source, in particular by a semiconductor memory which means a particularly low expenditure on circuitry and control.

Alternatively, according to another appropriate further development of the present invention, the flag memory is a non-electric storage memory, in particular a magnetic, optical, magneto-optic or holographic storage memory. This results in the advantage that electrical energy is not required for permanent storage of the respective initialisation signal.

The invention will now be explained in detail hereinafter with reference to an exemplary embodiment using drawings.

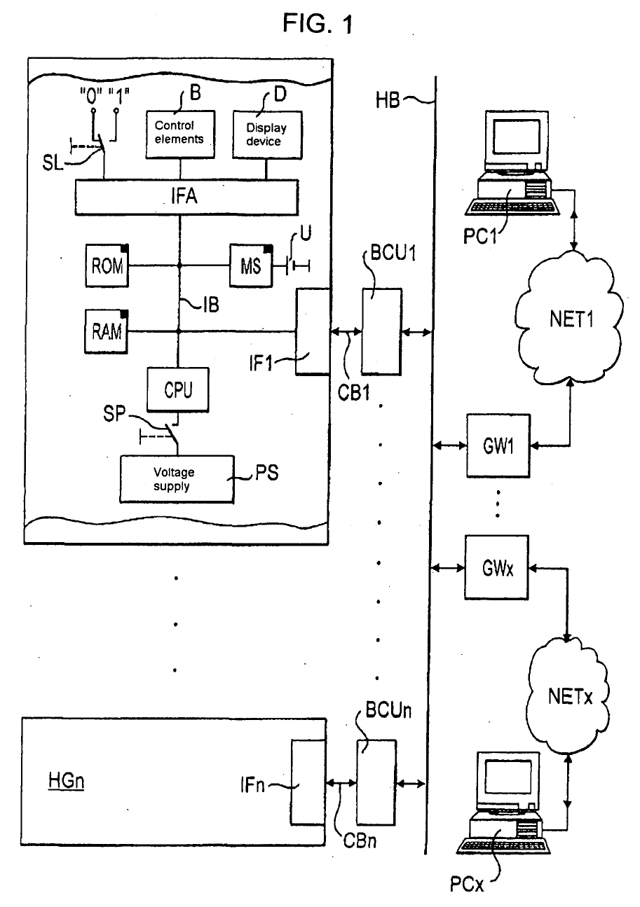

FIG. 1 is a schematic diagram showing a bus line arrangement pertaining to a network to which a plurality of household appliances is connected and which is connected to communication networks via transfer devices.

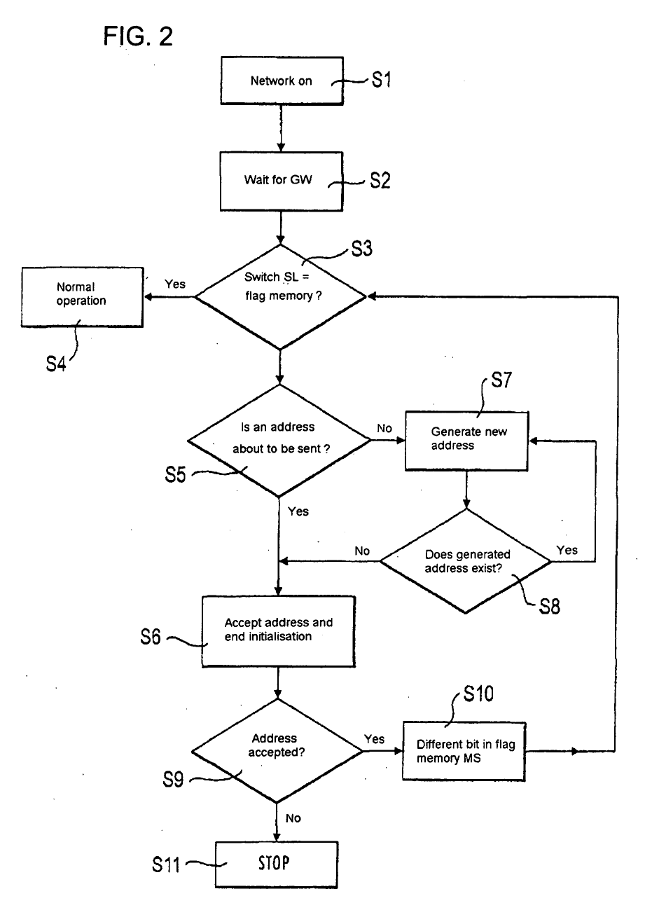

FIG. 2 is a flow diagram illustrating the sequence of checking an initialisation and/or registration state of an appliance and in particular, a household appliance in the arrangement shown in FIG. 1.

Shown schematically in FIG. 1 is a plurality of household appliances HG1 to HGn which are connected to a bus line arrangement via bus coupling units or bus couplers BCU1 to BCUn representing communication units which belong to a network or a first communication network. It should be noted here that arrangement shown in FIG. 1 corresponds in principle to an arrangement which has already been disclosed and explained in the DE patent application (correspond to DE 103 13 360 A1).

The aforementioned first communication network can be connected to external control and/or monitoring devices PC1 to PCx via transfer devices GW1 to GWx, also known as gateways.

The household appliances HG1 to HGn indicated in FIG. 1 comprise, for example, household appliances of the same or different types belonging to one household or several households, such as for example, one or more washing machines, one or more electric cookers, one or more dishwashers, one or more microwaves, one or more refrigerators, one or more fume extraction hoods, one or more air conditioning systems, one or more coffee machines, one or more vacuum cleaners, one or more cooking hobs, one or more freezers etc. The relevant household appliances HG1 to HGn are not shown in detail here. Rather only the elements necessary to understand the invention are shown, more precisely only for the household appliance HG1.

Among other things, the aforementioned elements of the household appliance HG1 include a central unit CPU which is connected to an internal bus IB to which a read-only memory ROM and a read-write memory RAM as well as a display device D and control elements B are connected via an interface device IFA operated in parallel or in series inside the household appliance. The read-only memory ROM can store work programs used to operate the household appliance HG1 which can be executed with the aid of the central unit CPU. The read-write memory RAM serves as a random access memory for the memory system shown in the course of executing these work programs. The central unit CPU together with the ROM and RAM memories can be used for executing various tasks such as for executing comparison and evaluation processes still to be explained when carrying out the method according to the invention.

The central unit CPU is connected to a voltage supply device PS via a switch SP indicated in FIG. 1, which can either be the voltage supply device of the household appliance HG1 such as, for example, the mains voltage supply device of this household appliance or the dedicated or separate voltage supply device of this household appliance HG1. In the last-mentioned case, this voltage supply device PS is still available, for example, in the event of a failure of the supply or mains voltage used to operate the relevant household appliance HG1 so that specific status or message signals for possible remote interrogation can be provided by the internal computer system (CPU, ROM, RAM) of the household appliance.

In the present case, an interface device IF1 is connected to the internal bus IB of the household appliance HG1 which represents a bus line arrangement comprising a plurality of individual conductors, which is used for communication connections to and from the relevant household appliance HG1. This interface device IF1 can, for example, be a serial interface device or a parallel interface device such as is usually used for data transmission. The previously mentioned remote interrogation can take place, for example, via this interface device IF1.

A mechanical switching device SL can also be connected to the previously mentioned interface device IFA of the household appliance HG1, this usually being located at a position in the household appliance HG1 which is not readily accessible (normally only accessible for service personnel). The mechanical switching device SL can be adjusted between at least two different switching positions and in the present case is only adjustable between these two different switching positions. In one switching position, this so-to-speak bistable mechanical switching device SL which can be formed, for example, by a changeover switch, can deliver a signal corresponding to a link signal or bit “0” to the interface device IFA. In its other switching position the relevant mechanical switching device IFA delivers a signal corresponding to a link signal or bit “1” to the interface device IFA. In principle, however, the relevant mechanical switching device SL can also deliver different address signals as signals which are different from one another according to their respective setting to the interface device IFA. These different signals are used within the scope of the present invention as initialisation signals whose delivery results in the relevant household appliance HG1 being registered in the network comprising the bus line arrangement HB and as a result of which a basic setting of different states, in particular an address acceptance, i.e. an initialisation, is made in the relevant household appliance, which will be discussed in further detail hereinafter.

The previously considered mechanical switching device SL can only be set in two stable switching positions here. However, it is also possible to provide a mechanical switching device which can be set, for example, in three different stable switching positions. Such a switching device could deliver to the interface device IFA, for example, no signal or a blocking signal which blocks starting of the household appliance in its first switching position or a signal corresponding to a binary signal “0” or a signal corresponding to a binary signal “1” in its second and third switching positions.

A flag memory MS is also connected to the internal bus IB pertaining to the household appliance HG1 according to FIG. 1 and in the present case this is a non-volatile memory independent of the power supply of the household appliance HG1 which stores the respective adjusting state of the mechanical switching device SL of the household appliance HG1. In the present case, this flag memory MS is an electrically storing semiconductor memory which is connected to a dedicated current source U, a back-up battery, which provides the relevant flag memory MS with the voltage required for signal storage. However, the relevant flag memory MS can also be formed by a non-electrical storage memory such as by a magnetic, optical, magneto-optic or holographic storage memory. In this case, the current source or back-up battery U shown in FIG. 1 can be dispensed with.

At this point, it should be noted that the previously considered flag memory MS need not necessarily be provided in the household appliance HG1; rather it can also be contained in devices such as in a bus coupler BCU1 connected to the household appliance HG1 which has the function of a control device for the household appliance HG1 within the scope of the present invention, as will become clear hereinafter.

With reference to the household appliance HGn indicated schematically in FIG. 1 it should be noted that this has the same circuitry structure as the household appliance HG1 considered previously. The indicated household appliance HGn is fitted with a dedicated interface device IFn in accordance with the previously mentioned interface device IF1. This interface device IFn can likewise be a parallel or serial interface device.

The household appliances HG1 to HGn are connected with their interface devices IF1 and IGFn to relevant bus couplers BCU1 to BCUn via connecting lines CB1 to CBn shown as bidirectionally operated connecting lines in FIG. 1. The household appliances HG1 to HGn are connected via these bus couplers BCU1 to BCUn to the first communication network which is shown in FIG. 1 by a line-bound communication network comprising a single bus line arrangement HB which can have a plurality of single lines. The afore-mentioned bus couplers BCU1 to BCUn are used among other things to convert appliance-specific protocols or data formats (that is, so-called proprietary protocols) into bus-standard or standardised protocols or data formats and conversely are used to convert bus-standard or standardised protocols or data formats used in the bus line arrangement HB into appliance-specific protocols or data formats for the individual household appliances. Thus, in this case not the household appliances HG1 to HGn alone but primarily the bus couplers BCU1 to BCUn are responsible for the data exchange and the bus-typical network management.

In cases where the household appliances HG1 to HGn are located, for example, in one house or in neighbouring houses, the bus line arrangement HB forming the aforementioned first communication network or belonging to said network can be a so-called house or home bus which forms the first communication network for all the household appliances present in the relevant house or in the relevant houses.

At this point it should be noted that the first communication network (HB) can also be a line-bound communication network, the communication lines whereof are formed by current or voltage supply lines of the individual household appliances fed by a mains voltage source. That is, in this case the communications between the bus couplers BCU1 to BCUn and transfer devices or gateways take place via current or voltage supply lines of the individual household appliances which are connected to the relevant bus couplers BCU1 to BCUn and aforementioned transfer devices or gateways.

In addition, the first communication network (HB) can also be operated as a radio network in which the individual household appliances communicated by means of transmitting-receiving devices which then fulfil the functions of the relevant bus couplers BCU1 to BCUn.

Transfer devices or gateways GW1 to GWx are connected to the bus line arrangement HB forming the first communication network in the exemplary embodiment according to FIG. 1 and the relevant first communication network is connected to further communication networks NET1 to NETx via these. These further communication networks NET1 to NETx can preferably comprise a public communication network or the internet. External control and/or monitoring devices, which can be formed, for example by personal computers PC1 to PCx are connected to the relevant further communication networks NET1 to NETx as indicated in FIG. 1.

Since the structure of the device or circuit arrangement shown in FIG. 1 has been explained within the scope required to understand the present invention, the method according to the present invention will now be explained in detail with reference to the flow diagram shown in FIG. 2. For this purpose, reference is made to the diagram of the household appliance HG1 shown in FIG. 1.

The case is first considered where one of the household appliances shown in FIG. 1, and specifically the household appliance HG1 is connected to the bus coupler BCU1 allocated to said appliance. In this case, an initialisation or registration phase for initialising and registering the relevant household appliance HG1 takes place whereby this household appliance HG1 can be connected at least in the network (HB).

This initialisation and registration phase is triggered by switching on the voltage supply device PS of the household appliance HG1 (network on) according to step S1 of the flow diagram in FIG. 2 in the household appliance HG1 and at the same time or previously or subsequently so that the bistable switching device SL1 shown in the household appliance HG1 in FIG. 1 is switched over from the position shown in the drawing in which it supplies a signal corresponding to a binary signal or bit “0” to the interface device IFA into its other position in which it supplies a signal corresponding to a binary signal or bit “1” to the interface device. As has been explained above in connection with the explanation of the structure of the household appliance HG1, instead of the aforementioned binary signals address signals can also be supplied via the switching device SL to the interface device IFA.

In the next step S2 it is then checked Whether a transfer device or a gateway GW1 to GWx is available for the relevant household appliance HG1 (wait for GW). If such a gateway is available, for example the gateway GW1, the process sequence continues to step 3. In principle, it could also be checked here whether a bus coupler is available for the relevant household appliance.

In step S3 it is checked in accordance with a specific combination function, for example, by the household appliance HG1 itself, and specifically here by software by the central unit CPU and the ROM and RAM memories, whether the switch or the switching device SL yields the same signal as the relevant flag memory MS. This is not the case here since it is assumed that a binary signal “0” is stored in the flag memory MS which is still in its initial state whereas a binary signal “1” is delivered by the switching device SL. Thus, the process sequence continues from step S3 to step S5. In step S5 it is checked whether an address, namely a house address is about to be sent by the bus coupler BCU1 relevant to the household appliance HG1 as a control device. If this is the case because an initialisation or registration phase is running, the process sequence continues to step S6 in which the relevant address or house address for the household appliance HG1 is accepted in the bus coupler BCU1 and additionally by the household appliance HG1 and initialisation is terminated.

However, if no address is about to be sent by the bus coupler BCU1, the process sequence goes from step S5 to step S7 which causes the bus coupler BCU1 to generate a new address. In response to the generation of a new address it is then checked in step S8 whether this generated address already exists, i.e. has already been allocated to another household appliance connected to the bus line arrangement or the house bus HB. If this is the case, the relevant bus coupler BCU1 is made to generate another new address. This process proceeds until finally in step S8 it is established that the address generated by the bus coupler BCU1 has not been used for any other household appliance connected to the bus line arrangement or the house bus HB. In this case, the process sequence then goes over to the aforementioned step S6. After the end of the initialisation phase in step S6 it is then checked in the following step S9 whether the address generated by the bus coupler BCU1 has been accepted in the household appliance HG1 or not. If it has been accepted, the process sequence continues in step 10 in which in the present case, the bit stored in the flag memory MS is changed, i.e. from bit “0” to bit “1”.

If it is ascertained in step S9 that the address generated by the bus coupler BCU1 has not been accepted in the household appliance HG1, in the following step S11 a stoppage is effected by delivering a stop command. In this case, it must be checked why the address has not been accepted.

If the household appliance HG1 is removed from the network or its voltage supply device PS is switched off and if the relevant household appliance HG1 is then connected to the network again at a time point or its voltage supply device is switched on again (network on), without the switching device SL of this household appliance HG1 having been actuated, steps S1, S2 and S3 initially run again according to the process sequence shown in FIG. 2. Since it is now established in step S3 that a binary signal “1” is stored in the flag memory MS and that a binary signal “1” is provided by the switching device SL, the process sequence now continues to step S4 however. This means that normal operation is present and that process steps S5 to S11 do not need to be executed. In this case, no renewed initialisation or registration phase is thus carried out.

However, if the switching device SL has been switched over before reconnecting the household appliance HG1 to the network or before switching on the voltage supply device for the household appliance HG1 again, i.e. has been brought into its switching position shown in FIG. 1, a corresponding initialisation or registration phase for this household appliance HG1 runs again as has been explained above for the first commissioning of the household appliance HG1.

The process sequences explained hereinbefore therefore only carry out an initialisation and therefore registration of the relevant household appliance HG1 in the network comprising the bus line arrangement or the house bus HB when it is established that there is a determined fixed combination relationship, and more accurately when it is established that there is a deviation between the adjusting state of the mechanical switching device SL of said appliance HG1 and the memory state of the separate flag memory MS. This establishment of a deviation between the adjusting state of the mechanical switching device SL of the household appliance HG1 and the memory state of the separate flag memory MS is carried here preferably in accordance with an EXCLUSIVE-OR function, that is in accordance with a non-equivalence function. The link table of such an EXCLUSIVE-OR function for two binary input signals is as follows:

| | | | | |
|---|---|---|---|---|
| a | 0 | 1 | 0 | 1 |
| b | 0 | 0 | 1 | 1 |
| Q | 0 | 1 | 1 | 0 |

Here a and b the input signal bits to be subjected to the EXCLUSIVE-OR function, i.e. firstly of the mechanical switching device SL and secondly of the flag memory MS. Q gives the respective output signal bit of the EXCLUSIVE-OR function.

As can be seen, “0” output signal bits are only delivered by the relevant EXCLUSIVE-OR function in the presence of identical input signals or bits (“0”, “0” and “1”, “1”) which corresponds to “YES” in step S3 according to FIG. 2. In the other two cases where different input signals or bits are present (“0”, “1” and “1”, “0”), output signals or bits “1” are output for EXCLUSIVE-OR function which corresponds to a NO output signal in step S3 according to FIG. 2.

At this point it should be noted that the comparison of the respective adjusting state of the aforementioned mechanical switching device SL of the household appliance HG1 with the memory state of the relevant flag memory MS of this household appliance HG1 can also be made in accordance with another combination function, such as for example in accordance with an equivalence function. Since the equivalence function and the non-equivalence or EXCLUSIVE-OR function are complementary to one another with regard to the output of the combination output signals, when implementing an equivalence function its output signal or bit “1” in step S3 according to FIG. 2 corresponds to a “YES” answer whereas a combination signal or bit “0” in this case would correspond to a “NO” answer in step S3 according to FIG. 2.

In principle, instead of a comparison of bits, it could also be possible to make a comparison of different address signals which are output by the mechanical switching device SL of the household appliance HG1 and which can each be stored in the relevant flag memory MS. Such address signals can also be compared in accordance with an EXCLUSIVE-OR function (non-equivalence) or in accordance with an equivalence function.

Finally it should be noted that the check carried out in connection with step S3 in the flow diagram in FIG. 2 in accordance with a certain combination function is optionally carried out not in the respective household appliance but elsewhere, for example in the bus coupler pertaining to the respective household appliance. In addition, the respective determined combination function can be executed not only according to software but also according to hardware.

### REFERENCE LIST

B Control elements
BCU1, BCUn Bus coupling unit, bus coupler
CB1, CBn Connecting lines
CPU Central unit
D Display device
GW Gateway
GW1, GWx Transfer device, gateway
HB Bus line arrangement, home or house bus
HG1, HGn Appliance, household appliance
IB Internal bus
IF1, IFn Interface device
IFA Interface device
MS Flag memory
NET1, NETx Communication networks
PC1, PCx Control/monitoring device, personal computer
PS Voltage supply device
RAM Read-write memory
ROM Read-only memory
S1, S2, S3, S4, S5 Step
S6, S7, S8, S9,
S10, S11
SL Mechanical switching device, switch
SP Switch
U Current source, backup battery

1-10. (canceled)

11. A method for carrying out initialization and/or registration steps for a device to be connected in a network, the method which comprises:
controlling a first initialization or registration of the device by way of a control device by delivering an initialization signal from the device in response to an actuation of a mechanical switching device and, in the course of the relevant initialization or registration, allocating to the device an address uniquely identifying the device in the network;
after the first initialization or registration of the device, storing an adjusting state signal corresponding to a switching state of the mechanical switching device, which is adjustable between respectively one of at least two stable switching positions, in a flag memory associated with the device;
after the device has been taken out of operation and then started up again in the network, checking an initialization or registration state of the device by comparing the adjusting state of the mechanical switching device with a memory state of the separate flag memory in accordance with a determined combination function; and
carrying out a renewed initialization or registration of the device in the network only when a presence is established of a determined fixed combination relationship between the adjusting state of the mechanical switching device of the device and the memory state of the separate flag memory.

12. The method according to claim 11, wherein the device is a household appliance.

13. The method according to claim 11, which comprises comparing the respective adjusting state of the mechanical switching device of the device with the memory state of the separate flag memory in accordance with an EXCLUSIVE OR function (non-equivalence) or in accordance with an equivalence function.

14. The method according to claim 11, which comprises storing the initialization signal delivered in each case by the mechanical switching device of the device in a non-volatile flag memory independent of a power supply of the device.

15. The method according to claim 14, wherein the flag memory is a memory supplied by a dedicated power source.

16. The method according to claim 15, wherein the flag memory (MS) is a semiconductor memory (MS).

17. The method according to claim 14, which comprises employing a non-electric storage memory as the flag memory (MS).

18. The method according to claim 18, wherein the memory is a magnetic memory, an optical memory, a magneto-optic memory, or a holographic storage memory.

19. A circuit configuration for carrying out initialization and/or registration steps for an appliance that can be connected to a network, wherein, in the course of the initialization or registration, an address uniquely identifying the device in the network is allocated to the device, the circuit configuration comprising:
a control device for controlling a first initialization or registration of the relevant appliance, said control device delivering an initialization signal from the device in response to an actuation of a mechanical switching device;
a mechanical switching device adjustable in at least two different switching positions in the appliance, said switching device issuing, in the different switching positions, mutually different initialization signals (e.g. “0” or “1”);
a flag memory for the appliance for storing the initialization signal issued in each case by actuation of said mechanical switching device;
a comparison device configured to check the initialization or registration state of the appliance and to compare the respective adjusting state of the mechanical switching device with the memory state of the separate flag memory before carrying out an initialization or registration of the relevant appliance, in accordance with a determined combination function for a commissioning and a re-installation of the relevant appliance following a respective operating interruption; and
an evaluation device configured to only trigger a renewed initialization or registration of the relevant appliance in the network when a presence of a determined fixed combination relationship between the respective adjusting state of the mechanical switching device and the memory state of said separate flag memory is established.

20. The circuit configuration according to claim 19, wherein the appliance is a household appliance.

21. The circuit configuration according to claim 19, configured to carry out the method according to claim 11.

22. The circuit configuration according to claim 19, wherein said comparison device is a comparison device configured to execute an EXCLUSIVE OR function (non-equivalence) or an equivalence function.

23. The circuit configuration according to claim 19, wherein said flag memory is a non-volatile flag memory independent of a power supply of the relevant appliance for storing an initialization signal.

24. The circuit configuration according to claim 23, wherein said flag memory includes a dedicated power source.

25. The circuit configuration according to claim 23, wherein said flag memory is a semiconductor memory with a dedicated power source.

26. The circuit configuration according to claim 23, wherein said flag memory is a non-electric storage memory.

27. The circuit configuration according to claim 26, wherein said flag memory is a magnetic memory, an optical memory, a magneto-optic memory, or a holographic storage memory.
